(19) United States
(12) Patent Application Publication
(10) Pub. No.: US 2015/0081756 A1
(43) Pub. Date: Mar. 19, 2015

(54) COMPUTER-READABLE STORAGE MEDIUM STORING CONTROL PROGRAM AND INFORMATION PROCESSING TERMINAL

(71) Applicant: FUJITSU LIMITED, Kawasaki-shi (JP)

(72) Inventor: Tomoyuki KUBOTA, Shizuoka (JP)

(73) Assignee: FUJITSU LIMITED, Kawasaki-shi (JP)

(21) Appl. No.: 14/467,388

(22) Filed: Aug. 25, 2014

(30) Foreign Application Priority Data
Sep. 13, 2013 (JP) 2013-191160

(51) Int. Cl. H04L 29/08; H04W 88/02

(52) U.S. Cl. CPC H04L 67/10; H04W 88/02
USPC 709/201

(57) ABSTRACT

A non-transitory computer-readable storage medium includes a control program that causes an information processing terminal with a wireless communication function to execute a process. The process includes obtaining operation definition information from an application program stored in the information processing terminal, the operation definition information defining a process performed in accordance with whether wireless communication is available; and uninstalling the application program corresponding to the operation definition information on the basis of the operation definition information when the wireless communication is unavailable.

### CROSS-REFERENCE TO RELATED APPLICATION

This application is based upon and claims the benefit of priority of the prior Japanese Patent Application No. 2013-191160, filed on Sep. 13, 2013, the entire contents of which are incorporated herein by reference.

### FIELD

The embodiments discussed herein are related to the control of an information processing terminal with a wireless communication function.

### BACKGROUND

In recent years, an information processing terminal capable of performing mobile communication, such as a smartphone or a tablet, is popular, but the leakage of information stored in the information processing terminal needs to be prevented. For that reason, in the information processing terminal capable of performing mobile communication, in order to prevent the leakage of information, the terminal is instructed from a remote place to lock the terminal (remote lock) or erase the contents of the terminal (remote wipe). This respect is described with reference to FIG. 1.

FIG. 1 is a diagram explaining an example of the remote lock or the remote wipe. Assume that a user 1 has lost an information processing terminal capable of performing mobile communication (hereinafter referred to as a “terminal”) 5. The user 1 first requests that an administrator 2 lock the terminal 5 or erase data in the terminal, in order to prevent the leakage of data stored in the terminal 5 or the abuse of the terminal 5 (S1).

The administrator 2 inputs, into a server 3, a command for locking the terminal 5 or erasing the data in the terminal (S2). The command is transmitted to the terminal 5 via a base station 4 (S3). The terminal 5 performs the locking or data erasure on the basis of the command (S4).

As described above, the remote lock or remote wipe is performed on the basis of the command from a remote place, and it is possible to lock the terminal 5 or erase data in the terminal when the terminal 5 is communicable.

However, when the terminal 5 is incommunicable, it is impossible for the terminal 5 to receive a command by remote control from a server 3 so as to lock the terminal 5 or erase data in the terminal. Therefore, it is impossible to prevent the leakage of application software installed on the terminal 5 or data stored in the terminal 5.

In addition, administrator authority of a terminal is needed for the execution of the remote lock or remote wipe. When a user does not have the administrator authority, the user needs to request that an administrator perform an operation, as illustrated in FIG. 1. In this case, it takes time before the execution of the remote lock or remote wipe, and therefore it is impossible to prevent the leakage of the application software installed on the terminal 5 or the data stored in the terminal 5, before the execution of the remote lock or remote wipe.

Here, there are the following techniques as an example of a technique for controlling an access to a terminal in a state in which the terminal is incommunicable with a server.

For example, there is a technique for defining an access control policy and further realizing a plurality of access control policies in an offline state (for example, Patent Document 1). In Patent Document 1, various patterns of access control policy in an offline state are included in an installation medium. The access control policies are stored in a client at the time of installation, information of a selected access control policy is registered in a token device in an offline state, and a client machine is connected. As a result, the policy in the offline state is reflected to the client machine.

In addition, there is a technique in which, when a wireless terminal with a function of installing software from the outside and executing the software moves out of a service range of a wireless communication system that the wireless terminal is currently using, the wireless terminal goes into an initial state (for example, Patent Document 2).

There is also a technique for automatically uninstalling application software under prescribed conditions (for example, Patent Document 3). Patent Document 3 discloses a method in a consumer system for determining whether an application is performing an illegal operation. In this method, when an application is installed, the limit is set to the service of a service provider that the application is allowed to use. Under the control, a runtime environment provides access to the set limit, to the application. When the application requests the service of the service provider, it is determined whether the request exceeds the set limit. When it is determined that the request does not exceed the set limit, the service provider is requested to provide the service. When it is determined that the request exceeds the set limit, the service provider is reported that the application is performing an illegal operation, and the execution of the application on the consumer system is prohibited. The prohibiting includes uninstalling the application.

There is also a method performed by a computer for uninstalling a specified application program and the relevant system setting and object from a computing system (for example, Patent Document 4). The specified application program is related to at least one file, and is one of a plurality of application programs installed on the computing system. In this method, the computer receives a request for uninstalling the specified application program. The computer determines an identifier relating to the specified application program. The computer identifies, via the determined identifier, a file associated with the determined identifier relating only to the specified application program of the plurality of application programs.

Patent Document 1: Japanese Laid-open Patent Publication No. 2010-250714

Patent Document 2: Japanese Laid-open Patent Publication No. 2001-61186

Patent Document 3: Japanese Laid-open Patent Publication No. 2005-259130

Patent Document 4: Japanese Laid-open Patent Publication No. 2005-129066

### SUMMARY

A non-transitory computer-readable storage medium includes a control program that causes an information processing terminal with a wireless communication function to execute a process. The process includes obtaining operation definition information from an application program stored in the information processing terminal, the operation definition information defining a process performed in accordance with whether wireless communication is available; and uninstalling the application program corresponding to the operation definition information on the basis of the operation definition information when the wireless communication is unavailable.

The information processing terminal includes a communication unit, a storage unit, and a controller. The communication unit performs wireless communication. The storage unit stores an application program associated with user environment information that manages a use environment of a log-in user, for each piece of user environment information. To the application program, the operation definition information is assigned that defines a process performed in accordance with whether the wireless communication is available. When the wireless communication is unavailable, the controller performs the following process on the basis of the operation definition information of a target application program corresponding to the user environment information of the log-in user. Namely, the controller uninstalls the target application program corresponding to the user environment information of the log-in user.

The information processing terminal includes a communication unit, a storage unit, and a controller. The communication unit performs wireless communication. The storage unit stores an application program associated with user environment information that manages a use environment of a log-in user, for each piece of user environment information. To the application program, operation definition information has been assigned that defines a process performed in accordance with whether the wireless communication is available. When the wireless communication is unavailable, the controller performs the following process on the basis of the operation definition information of a target application program corresponding to the user environment information of the log-in user. Namely, the controller uninstalls the target application program corresponding to the user environment information of the log-in user and the user environment information of a user that has not logged in.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram explaining an example of the remote lock or the remote wipe.

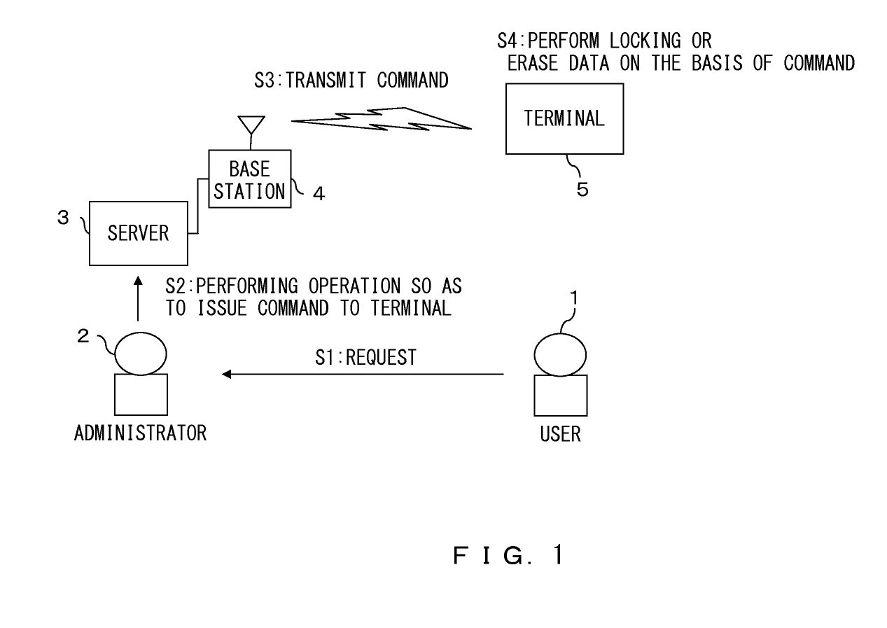

FIG. 2 illustrates an example of a block diagram of an information processing terminal according to the present embodiment.

FIG. 3 is a diagram explaining an example of a process of uninstalling a client App in accordance with a communication state of a terminal according to the first embodiment.

FIG. 4 is a functional block diagram of an information processing terminal according to the first embodiment.

FIG. 5 illustrates a hardware configuration of a terminal according to the first embodiment.

FIG. 6 illustrates an example of a user App list according to the first embodiment.

FIG. 7 illustrates an example of user management information according to the first embodiment.

FIG. 8A illustrates an example (no. 1) of operation definition information according to the first embodiment.

FIG. 8B illustrates an example (no. 2) of operation definition information according to the first embodiment.

FIG. 8C illustrates an example (no. 3) of operation definition information according to the first embodiment.

FIG. 8D illustrates an example (no. 4) of operation definition information according to the first embodiment.

FIG. 8E illustrates an example (no. 5) of operation definition information according to the first embodiment.

FIG. 8F illustrates an example (no. 6) of operation definition information according to the first embodiment.

FIG. 9 is a diagram explaining processes of uninstalling a client App and deleting user data according to the first embodiment.

FIG. 10 is a flowchart illustrating a process of obtaining operation definition information according to the first embodiment.

FIG. 11 is a flowchart illustrating a process of uninstalling a client App or erasing user data according to the first embodiment.

FIG. 12 is a diagram explaining operation definition information according to the second embodiment.

FIG. 13 is a flowchart illustrating a process of obtaining operation definition information according to the second embodiment.

FIG. 14A is a flowchart (no. 1) illustrating a process of uninstalling a client App or erasing user data according to the second embodiment.

FIG. 14B is a flowchart (no. 2) illustrating a process of uninstalling a client App or erasing user data according to the second embodiment.

### DESCRIPTION OF EMBODIMENTS

In the technique described in Patent Document 2, a wireless terminal goes into an initial state when the wireless terminal moves out of a service range of a wireless communication system, and in the technique described in Patent Document 3, application software is uninstalled using uniform conditions.

However, application programs installed on a terminal are not always the same in criteria for judging the necessity of uninstallation. For example, when criteria for judging the necessity of uninstallation differs depending on the type or use of an application, it is not appropriate to uniformly perform the uninstallation without considering the circumstances of each of the application programs, as described in the techniques above.

One aspect of the present invention provides a technique for individually controlling a process of autonomously uninstalling an application program in accordance with the communication status of wireless communication.

Here are the embodiments. It is desirable that a terminal go into an autonomously secure state in accordance with an operation state of a user, a state of a terminal, such as the availability of mobile communication, or the like, without receiving an instruction from an administrator.

When a terminal capable of mobile communication is limited to the reference to data or the input of data, information processed by the terminal is limited to information stored in a memory, and data is processed on a server. As a result, it is possible to prevent the leakage of information by the terminal lock or remote lock after the lapse of a prescribed period of time, in most cases.

On the other hand, due to an increase in information processing performance or storage capacity in a terminal such as a tablet, an opportunity to store important data in a terminal, or an opportunity to incorporate a business logic into an application program used in a terminal and to process data, arises. When data stored in a terminal or an application program is a target for preventing the leakage, it is preferable that the uninstallation of an application program and the erasure of data be performed at the same time.

In addition, in order to appropriately perform the uninstallation of the application program or the erasure of the data, it is preferable that not only the uninstallation or the erasure be performed in accordance with an instruction from an administrator, such as the remote lock or the remote wipe, but a terminal also operate as the following. For example, it is preferable that a terminal operate so as to go into a secure state in accordance with a state of an operation by a user, a state of a terminal, such as the availability of mobile communication, or the like, without receiving an instruction from an administrator.

There is a technique in which an application program operates so as to uninstall the application program itself. However, it is difficult to surely uninstall the application program itself and to surely erase relevant data at the same time. For example, when each application is made to perform uninstallation under prescribed conditions, all of the application programs always determine whether the programs meet the conditions, duplicated processes are always performed, and therefore many resources of a terminal are consumed. As a result, resources that each application can use are limited, and it is impossible to perform an original process of an application program with satisfactory performance. Further, as a result of consuming many resources as described above, the power of the terminal is wasted.

Even when an uninstallation process is incorporated into each application program, there is a possibility that an uninstallation process is not surely performed due to the influence of another application program, such as the competition with another application program.

In order to avoid this, it is considered to centralizedly manage application programs. However, as described above, when an uninstallation process is uniformly performed, all of the applications are uninstalled every time any one of the applications in a terminal meets uninstallation conditions, and a user environment in the terminal needs to be reconstructed. Therefore, the techniques described above are insufficient in the viewpoint of the control of the information security.

In view of the foregoing, in the embodiments below, described is individually controlling a process of autonomously uninstalling an application program in accordance with a communication status of wireless communication.

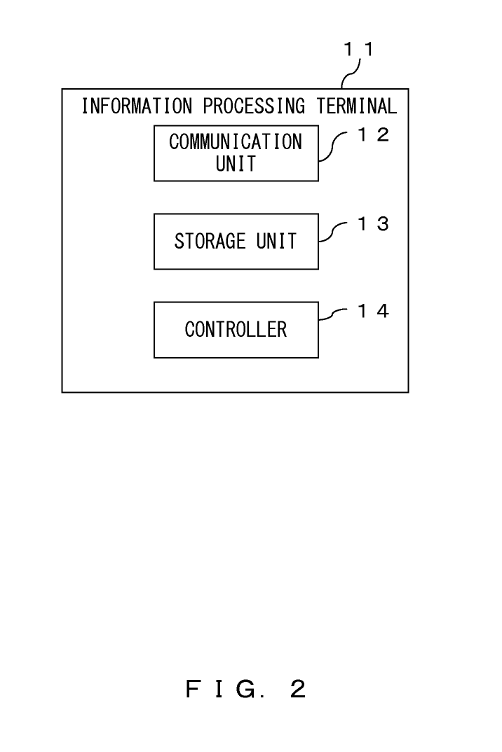

FIG. 2 illustrates an example of a block diagram of an information processing terminal according to the present embodiment. As an example of the present embodiment, an information processing terminal 11 includes a communication unit 12, a storage unit 13, and a controller 14.

The communication unit 12 performs wireless communication. An example of the communication unit 12 is a communication I/F 46.

The storage unit 13 stores an application program to which operation definition information has been assigned that defines a process performed in accordance with whether the wireless communication is available. An example of the storage unit 13 is a ROM 43 or a storage device 47.

When the wireless communication is unavailable, the controller 14 uninstalls an application program corresponding to the operation definition information on the basis of the operation definition information. An example of the controller 14 is a CPU 42.

The configuration above enables individually controlling a process of autonomously uninstalling an application in accordance with a communication status of wireless communication.

Further, when the wireless communication is unavailable, the controller 14 uninstalls the application program corresponding to the operation definition information on the basis of the operation definition information, and erases data related to the application program at the same time.

The configuration above enables individually controlling processes of autonomously uninstalling an application program and erasing the data thereof in accordance with a communication status of wireless communication.

As another example of the present embodiment, an information processing terminal 11 includes a communication unit 12, a storage unit 13, and a controller 14.

The communication unit 12 performs wireless communication. An example of the communication unit 12 is a communication I/F 46.

The storage unit 13 stores an application program associated with user environment information that manages a use environment of a log-in user, for each piece of the user environment information. To the application program, operation definition information has been as signed that defines a process performed in accordance with whether the wireless communication is available. An example of the storage unit 13 is a ROM 43 or a storage device 47.

When the wireless communication is unavailable, the controller 14 performs the following process on the basis of the operation definition information of a target application program corresponding to the user environment information of the log-in user. Namely, the controller 14 uninstalls the target application program corresponding to the user environment information of the log-in user. An example of the controller 14 is a CPU 42.

The configuration above enables individually controlling a process of autonomously uninstalling an application program in accordance with a communication status of wireless communication in a user environment of a log-in user, in an information processing terminal having a multi-user environment.

As another example of the present embodiment, an information processing terminal 11 includes a communication unit 12, a storage unit 13, and a controller 14.

The communication unit 12 performs wireless communication. An example of the communication unit 12 is a communication I/F 46.

The storage unit 13 stores an application program associated with user environment information that manages a use environment of a log-in user, for each of the user environment information. To the application program, operation definition information has been assigned that defines a process performed in accordance with whether the wireless communication is available.

When the wireless communication is unavailable, the controller 14 performs the following process on the basis of the operation definition information of a target application program corresponding to the user environment information of a log-in user. Namely, the controller 14 uninstalls the target application program corresponding to the user environment information of the log-in user and the user environment information of a user that has not logged in.

The configuration above enables individually controlling a process of autonomously uninstalling an application program in accordance with a communication status of wireless communication in a user environment of a log-in user, in an information processing terminal having a multi-user environment. Further, the configuration above enables individually controlling a process of autonomously uninstalling the same application program in a user environment of a user other than the log-in user.

As an example of the present embodiment, a first embodiment and a second embodiment are described below. These embodiments are examples, and the processing procedure, a data structure, or the like, is not limited.

### First Embodiment

In the first embodiment, described below is individually controlling a process of autonomously uninstalling an application program in accordance with a communication state of wireless communication in a user environment of a log-in user in an information processing terminal having a single-user environment or a multi-user environment. Hereinafter, the application program is referred to as an “App”.

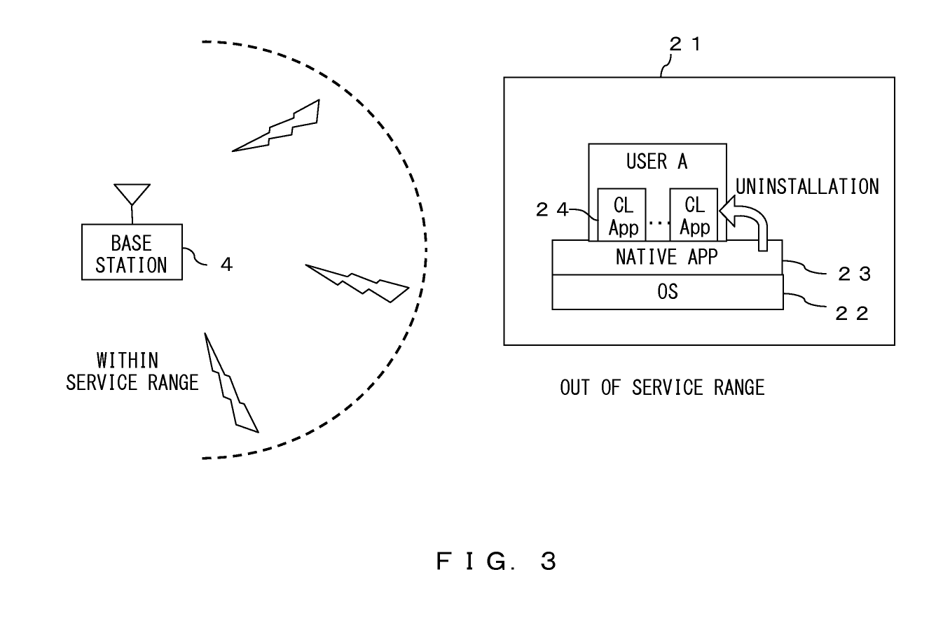

FIG. 3 is a diagram explaining an example of a process of uninstalling a client App in accordance with a communication state of a terminal according to the first embodiment. A terminal 21 includes an operating system (OS) 22, a native App 23, and a client App (CL App) 24. The client App is a generic term for an App for the native App 23, and refers to an App controlled by the native App 23 of the Apps.

The OS 22 is basic software that operates the terminal 21. The OS 22 includes user environment information that each user can use such that a single-user or a multi-user can log in, and installed application software (client App) 24 is also managed for each piece of the user environment information.

The native App 23 is application software that runs on the OS 22, and performs the download, installation, and uninstallation of the client App, and the reference to metadata. On the native App 23, the client App 24 runs that has been installed on a storage device in the terminal 21. In addition, the client App 24 is managed for each log-in user.

In a service range of a base station 4, namely, when a communication state is satisfactory, nothing occurs to a prescribed client App 24 installed on the terminal 21. However, outside the service range of the base station 4, namely, when the communication state is poor, the native App 23 uninstalls the prescribed client App 23 from the storage device in the terminal 21.

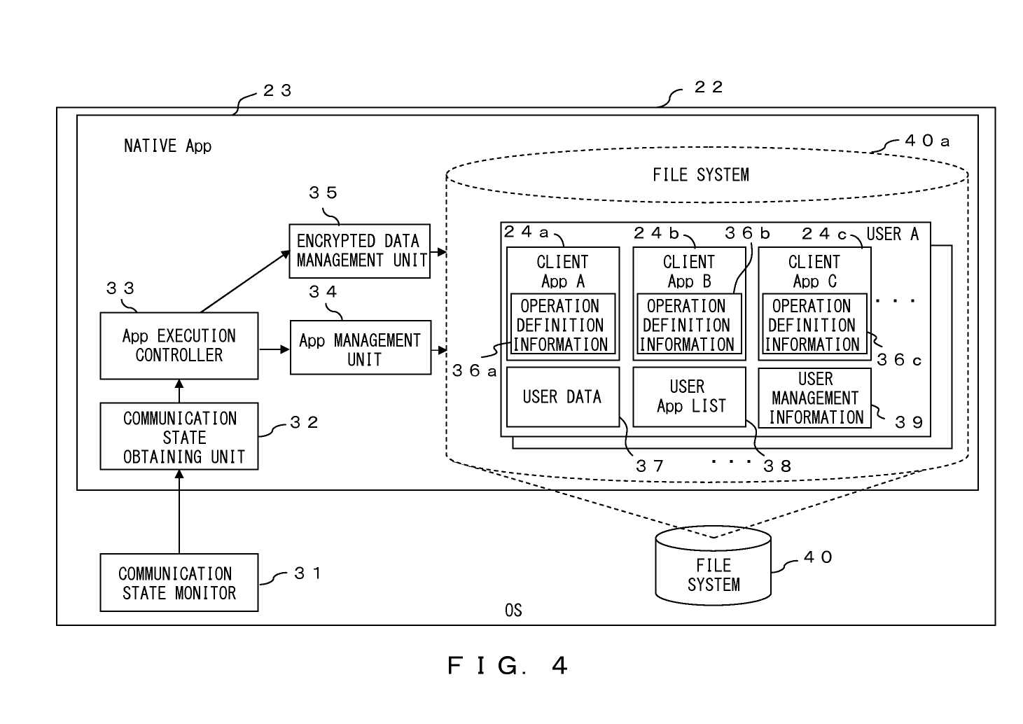

FIG. 4 is a functional block diagram of an information processing terminal according to the first embodiment. The OS 22 includes a communication state monitor 31 and a file system 40. The communication state monitor 31 monitors information on a communication state of a terminal, and notifies a communication state obtaining unit 32 of the monitoring result. The information on the communication state of the terminal refers to online/offline information of a communication network (e.g., 3G/LTE (Long Term Evolution) or Wi-Fi) issued by a smart device. The file system refers to a system that manages data stored in a storage device.

The native App 23 can use a file system 40a assigned to the native App 23 of the file system 40 in the OS 22. The file system 40a manages, in log-in user units, a client App 24, user data 37, a user App list 38, user management information 39, and the like, that have been installed on the terminal 21. The native App 23 grasps an operation state of an operating App by using the file system 40a. The user data 37 is data used by the installed client App in a log-in user environment. The user data is managed by the file system 40a. In addition, the user data is stored in an encrypted data region 48 described later, in which data is encrypted and stored, in the storage device 47 of the terminal 21.

The user App list 38 is a list of the installed App in the log-in user environment. The user management information 39 is information that manages the installed client App and the data used by the client App 24 (user data) in the log-in user environment.

The client Apps 24 (24a, 24b, 24c, . . . ) respectively include pieces of operation definition information 36 (36a, 36b, 36c, . . . ). In the operation definition information 36, the contents performed when an executable condition is met in accordance with a communication state and a force-uninstall process designated if needed when the executable condition is not met are defined for each of the client Apps.

The native App 23 includes a communication state obtaining unit 32, an App execution controller 33, an App management unit 34, and an encrypted data management unit 35. The communication state obtaining unit 32 obtains information on the communication state of the terminal 21 that has been reported from the communication state monitor 31.

The App execution controller 33 controls the execution and stop of the client App 24. In addition, the App execution controller 33 reads the operation definition information 36 of the client App 24 via the App management unit 34. When the operation definition information 36 includes an instruction to uninstall the client App, the App execution controller 33 instructs the App management unit 34 to uninstall the client App under a prescribed condition. When the operation definition information 36 includes an instruction to erase data related to the client App, the App execution controller 33 issues an instruction to uninstall the client App and an instruction to erase user data related to the client App 24 to the App management unit 34 under a prescribed condition.

The App management unit 34 performs the download, installation, and uninstallation of the client App, and the reference to metadata. For example, the App management unit 34 uninstalls the App 24 managed by the file system 40a on the basis of the instruction from the App execution controller 33.

The encrypted data management unit 35 encrypts the user data and writes the encrypted user data, decrypts the user data and reads the decrypted user data, or erases the encrypted user data, via the file system 40a on the basis of the instruction from the App execution controller 33.

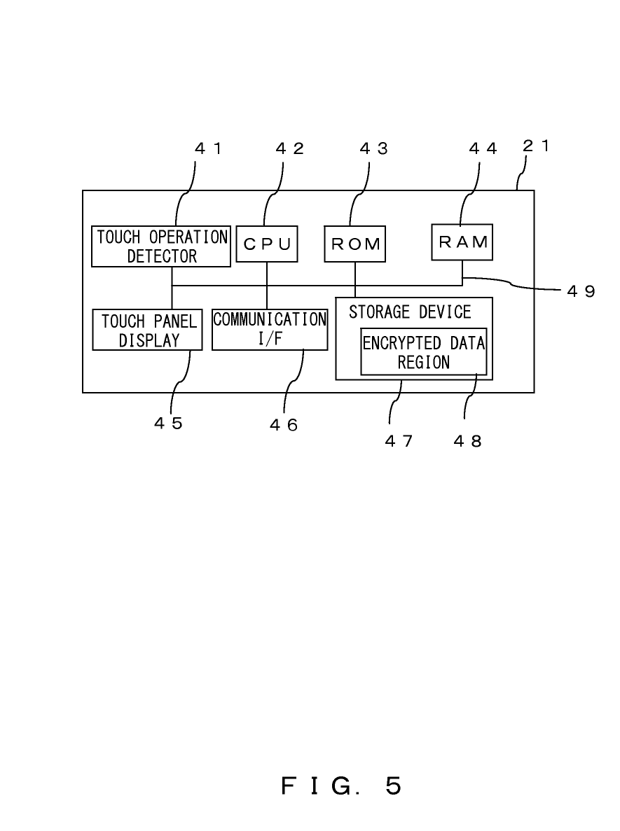

FIG. 5 illustrates a hardware configuration of a terminal according to the first embodiment. The terminal 21 includes a touch operation detector 41, a CPU 42, a ROM 43, a RAM 44, a touch panel display 45, a communication I/F 46, a storage device 47, and a bus 49.

Here, the CPU is an example of a processor, and refers to a central processing unit. The ROM refers to a read only memory. The RAM refers to a random access memory. The I/F refers to an interface. To the bus 49, a touch operation detector 41, the CPU 42, the ROM 43, the RAM 44, the touch panel display 45, the communication I/F 46, and the storage device 47 are connected.

The touch panel display 45 is a display by which a touch operation is performed. The touch operation detector 41 detects an input into the touch panel display 45.

Various types of storage device, such as a hard disk, a flash memory, or a magnetic disk, are used for the storage device 47. The storage device 47 includes an encrypted data region 48 that encrypts data and stores the encrypted data. In the storage device 47 or the ROM 43, a program and data used for performing a process according to the present embodiment are stored.

The CPU 42 reads each program, such as the OS 22, the native App 23, the client App 24, that has been stored in the storage device 47 or the like, and executes the program.

The communication I/F 46 is a communication control circuit as a communication interface that meets each type of communication standard, such as 3G, LTE, or Wi-Fi. The communication I/F 46 reports that the terminal is in a communicable state, when the terminal is communicable using each type of communication standard. When the terminal is incommunicable using each type of communication standard (for example, when the terminal is out of a communication range), the communication I/F 46 reports that the terminal is in an incommunicable state.

A program that realizes the processes described in the above embodiment may be stored in, for example, the storage device 47 via a communication network and the communication I/F 46 from the side of a program provider. Alternatively, the program that realizes the processes described in the present embodiment may be stored in a portable storage medium that is commercially available and is being distributed. Various types of storage medium, such as a CD-ROM, a flexible disk, an optical disk, a magneto-optical disk, an IC card, or a USB memory device, are used for the portable storage medium.

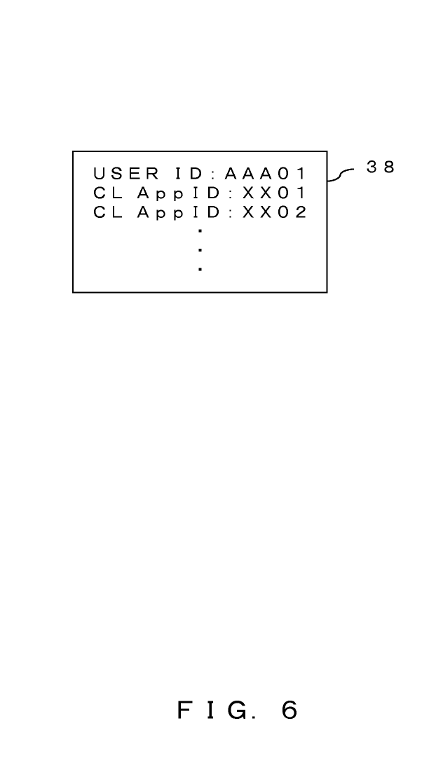

FIG. 6 illustrates an example of a user App list according to the first embodiment. The user App list 38 is managed in user units, and is a list of the client App installed on the terminal 21 in a log-in environment of a user. The user App list 38 includes a “user ID” and a “CL App ID”. The “user ID” is identification information that identifies a log-in user. The “CL App ID” is identification information that is assigned by a server from which the client App has been downloaded and that identifies the client App.

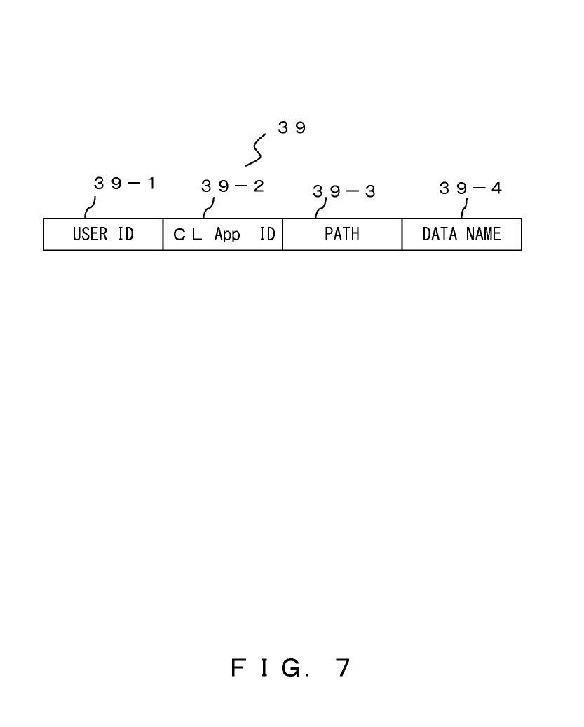

FIG. 7 illustrates an example of user management information according to the first embodiment. The user management information 39 is information that manages an installed client App and data used by the client App 24 (user data), in a log-in user environment.

The user management information 39 includes a “user ID” 39-1, a “CL App ID” 39-2, a “path” 39-3, and a “data name” 39-4. The “user ID” 39-1 is identification information that identifies a log-in user. The “CL App ID” 39-2 is identification information that is assigned by a server from which the client App has been downloaded and that identifies the client App. The “path” 39-3 indicates the location of user data used by the client App in the file system 40a. The “data name” 39-4 is a data name of a client App (binary data) or user data stored in the location specified by the “path” 39-3.

The user management information 39 uses the CL App ID for extracting user data generated by a target client App.

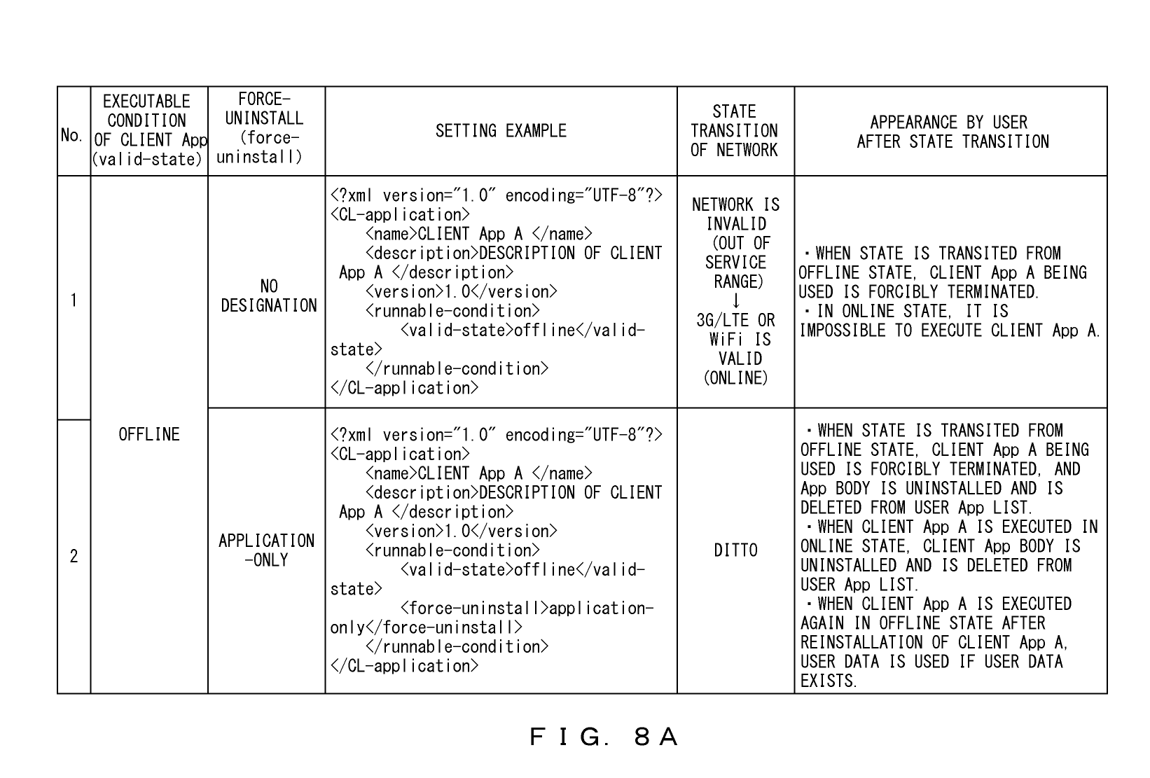

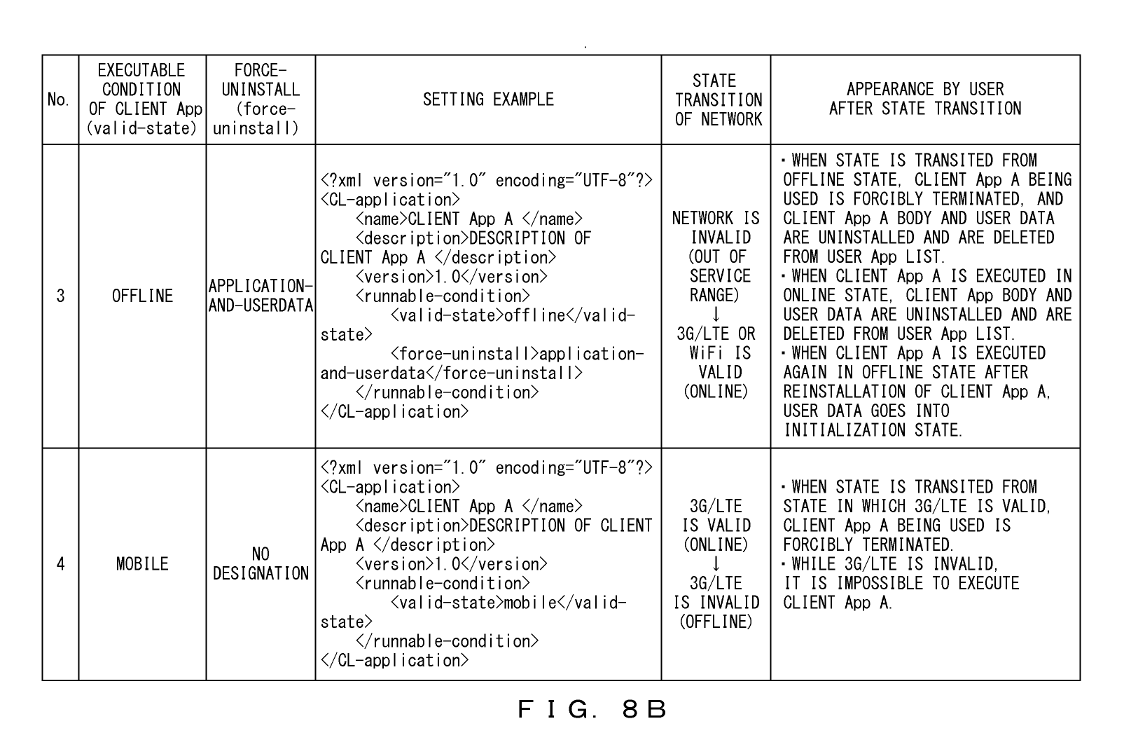

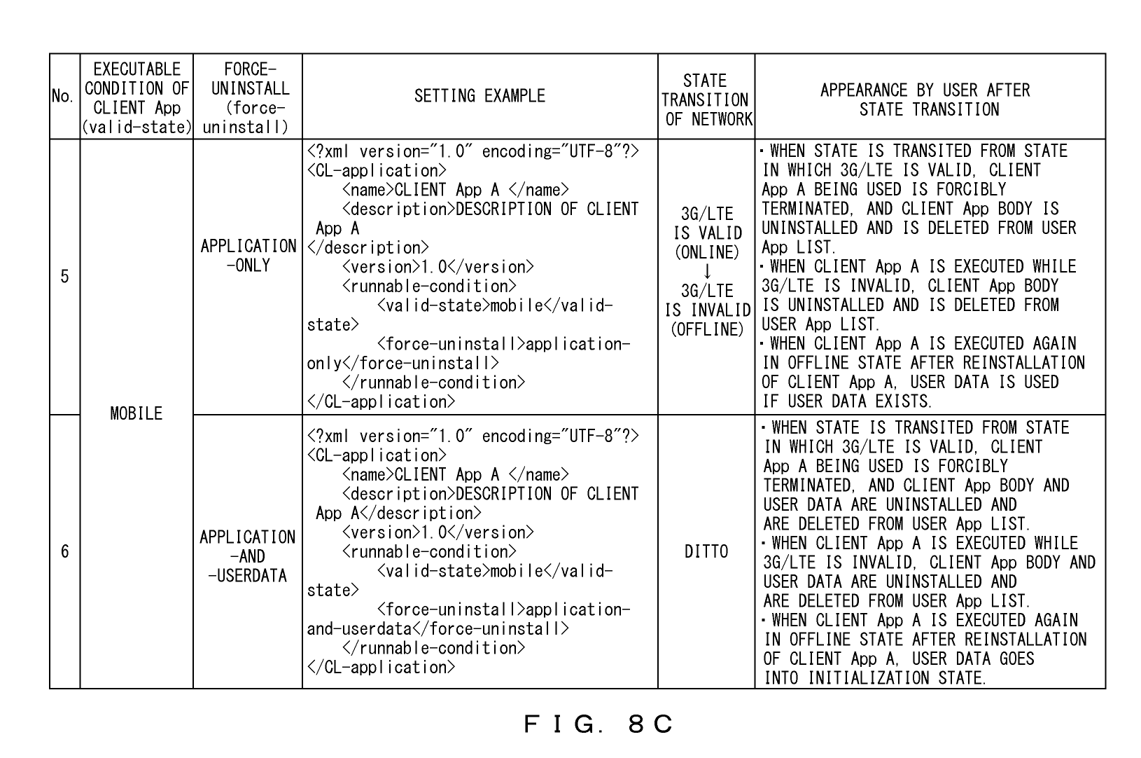

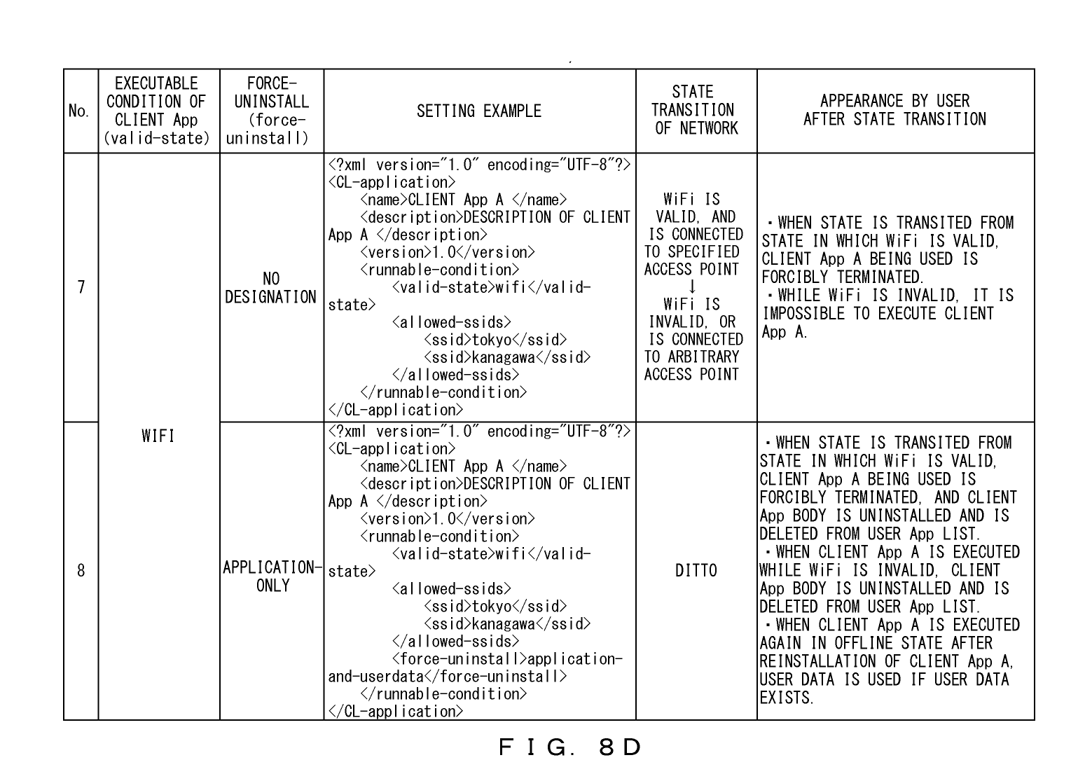

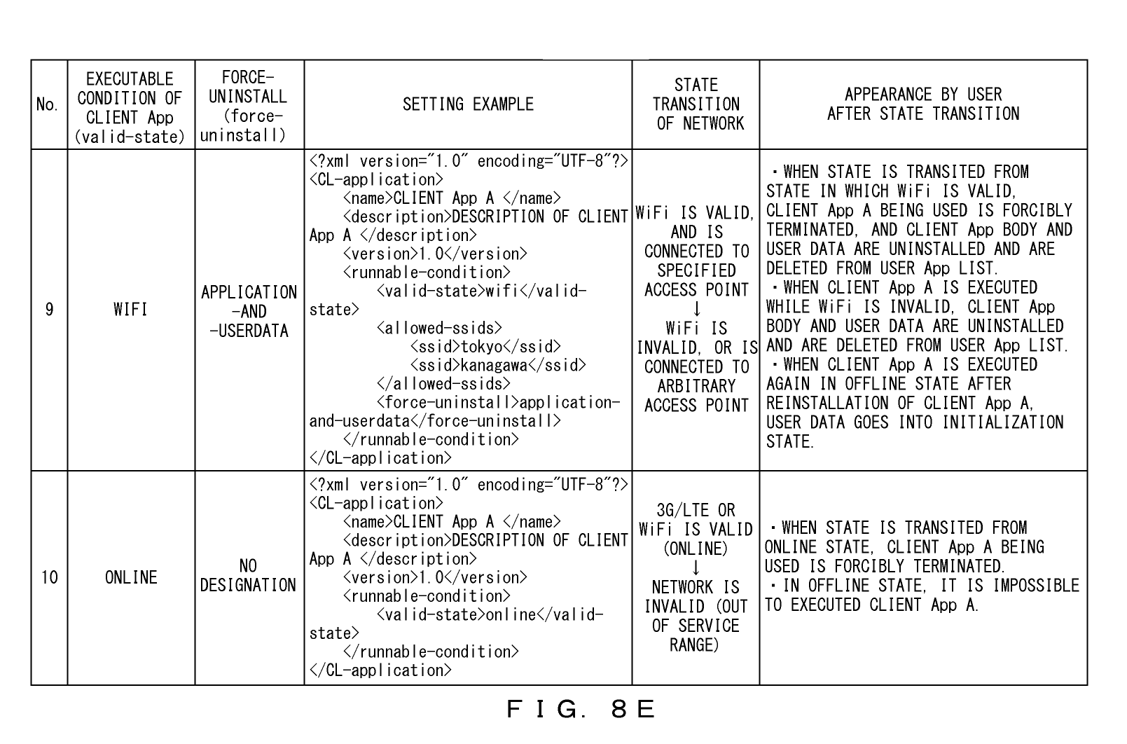

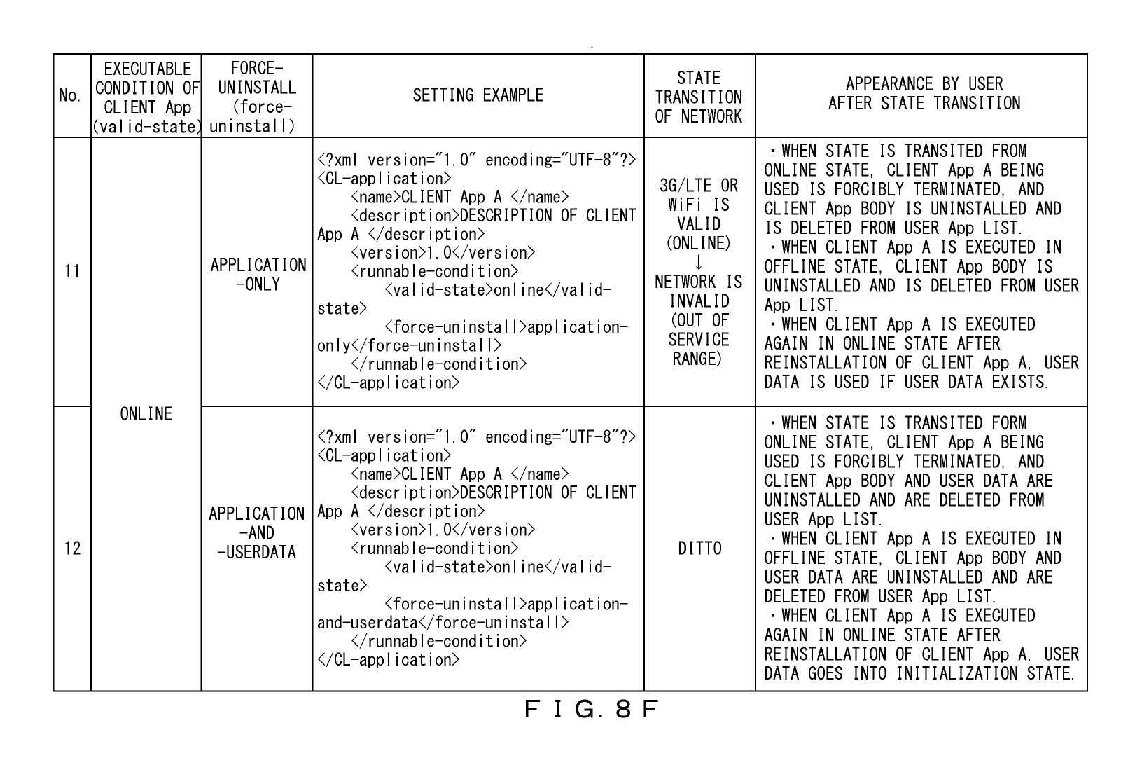

FIGS. 8A-8F illustrate examples of operation definition information according to the first embodiment. In the present embodiment, each of the client Apps includes meta information in which an operation is defined in XML (Extensible Markup Language), i.e., the operation definition information 36. In the operation definition information 36 illustrated in FIGS. 8A-8F, “CL-application” indicates a root tag. For “name”, a name of a client App is set. For “description”, the description of the client App is set. For “version”, aversion of the client App is set.

For “runnable-condition”, the definition of the execution of the client App is set as described below.

In “valid-state”, a state in which a client App is executable (executable condition) is designated. A value designated for “valid-state” is “offline”, “mobile”, “wifi”, or “online”. In a case in which the client App is desired to be operated when all of the networks are in an offline state, “offline” is designated. In a case in which the client App is desired to be operated when only mobile communication is in an online state, “mobile” is designated. In a case in which the client App is desired to be operated when WiFi communication is in an online state between specified access points, “wifi” is designated. In a case in which the client App is desired to be operated when mobile communication or WiFi communication is in an online state, “online” is designated.

“force-uninstall” is designated in a case in which the client App, or the client App and user data are forcibly uninstalled when the client App is changed from an executable state to an unexecutable state, namely, when the client App does not meet the executable condition. A value designated for “force-uninstall” is “application-only” or “application-and-userdata”. When only the client App is desired to be forcibly uninstalled, “application-only” is designated. When the client App and the user data are desired to be forcibly uninstalled, “application-and-userdata” is designated.

FIGS. 8A-8F illustrate setting examples of “runnable-condition”. Described below is each of the setting examples.

(Case No. 1)

Assume that, when “offline” is designated for the executable condition of the client App (valid-state) and nothing is designated for the force-uninstall, a network is changed from a state in which the network is invalid (out of a service range) to a state in which 3G/LTE or WiFi is valid. In this case, a client App A being used is forcibly terminated. In an online state, it is impossible to execute the client App A.

(Case No. 2)

Assume that, when “offline” is designated for the executable condition of the client App (valid-state) and “application-only” is designated for the force-uninstall, a network state is changed from a state in which the network is invalid (out of a service range) to a state in which 3G/LTE or WiFi is valid. In this case, a client App A being used is forcibly terminated, a client App body is uninstalled, and the client App is deleted from a user App list. When the client App A is executed in an online state, the client App body is uninstalled, and is deleted from the user App list. When the client App A is executed again in an online state after the reinstallation of the client App A, the client App A uses user data if the user data exists.

(Case No. 3)

Assume that, when “offline” is designated for the executable condition of the client App (valid-state) and “application-and-userdata” is designated for the force-uninstall, the network is changed from a state in which the network is invalid (out of a service range) to a state in which 3G/LTE or WiFi is valid. In this case, a client App A being used is forcibly terminated, a client App A body and user data are uninstalled, and the client App is deleted from a user App list. When the client App A is executed in an online state, the client App body and the user data are uninstalled, and the client App is deleted from the user App list. When the client App A is executed again in an offline state after the reinstallation of the client App A, the user data goes into an initialization state.

(Case No. 4)

Assume that, when “mobile” is designated for the executable condition of the client App (valid-state) and nothing is designated for the force-uninstall, the network is changed from a state in which 3G/LTE or WiFi is valid to a state in which 3G/LTE or WiFi is invalid (offline). In this case, a client App being used is forcibly terminated. It is impossible to execute the client App Awhile 3G/LTE is invalid.

(Case No. 5)

Assume that, when “mobile” is designated for the executable condition of the client App (valid-state) and “application-only” is designated for the force-uninstall, the network is changed from a state in which 3G/LTE or WiFi is valid to a state in which 3G/LTE or WiFi is invalid (offline). In this case, a client App A being used is forcibly terminated, and a client App body is uninstalled and is deleted from a user App list. When the client App A is executed while 3G/LTE is invalid, the client App body is uninstalled, and is deleted from the user App list. When the client App A is executed again in an offline state after the reinstallation of the client App A, the client App uses user data if the user data exists.

(Case No. 6)

Assume that, when “mobile” is designated for the executable condition of the client App (valid-state) and “application-and-userdata” is designated for the force-uninstall, the network is changed from a state in which 3G/LTE or WiFi is valid to a state in which 3G/LTE or WiFi is invalid (offline). In this case, a client App A being used is forcibly terminated, and a client App body and user data are uninstalled and are deleted from a user App list. When the client App A is executed while 3G/LTE is invalid, the client App body and the user data are uninstalled, and are deleted from the user App list. When the client App A is executed again in an offline state after the reinstallation of the client App A, the user data goes into an initialization state.

(Case No. 7)

Assume that, when “wifi” is designated for the executable condition of the client App (valid-state) and nothing is designated for the force-uninstall, the network is changed from a state in which WiFi is valid and is connected to a specified access point to a state in which WiFi is invalid or is connected to an arbitrary access point. In this case, a client App A being used is forcibly terminated. It is impossible to execute the client App A while WiFi is invalid.

(Case No. 8)

Assume that, when “wifi” is designated for the executable condition of the client App (valid-state) and “application-only” is designated for the force-uninstall, a network state is transited as the following. Namely, the network state is changed from a state in which WiFi is valid and is connected to a specified access point to a state in which WiFi is invalid or is connected to an arbitrary access point. In this case, a client App A being used is forcibly terminated, and a client App body is uninstalled and is deleted from a user App list. When the client App A is executed while WiFi is invalid, the client App body is uninstalled, and is deleted from the user App list. When the client App A is executed again in an offline state after the reinstallation of the client App A, the client App A uses use data if the user data exists.

(Case No. 9)

Assume that, when “wifi” is designated for the executable condition of the client App (valid-state) and “application-and-userdata” is designated for the force-uninstall, a network state is transited as the following. Namely, assume that the network state is changed from a state in which WiFi is valid and is connected to a specified access point to a state in which WiFi is invalid or is connected to an arbitrary access point. In this case, a client App A being used is forcibly terminated, a client App body and user data are uninstalled, and the client App is deleted from a user App list. When the client App A is executed while WiFi is invalid, the client App body and the user data are uninstalled, and the client App is deleted from the user App list. When the client App A is executed again in an offline state after the reinstallation of the client App A, the user data goes into an initialization state.

(Case No. 10)

Assume that, when “online” is designated for the executable condition of the client App (valid-state) and nothing is designated for the force-uninstall, the network is changed from a state in which 3G/LTE or WiFi is valid (online) to a state in which the network is invalid (out of a service range). In this case, a client App A being used is forcibly terminated. It is impossible to execute the client App A in an offline state.

(Case No. 11)

Assume that, when “online” is designated for the executable condition of the client App (valid-state) and “application-only” is designated for the force-uninstall, a network state is transited as the following. Namely, the network state is changed from a state in which WiFi is valid and is connected to a specified access point to a state in which WiFi is invalid or is connected to an arbitrary access point. In this case, a client App A being used is forcibly terminated, and a client App body is uninstalled and is deleted from a user App list. When the client App A is executed in an offline state, the client App body is uninstalled, and is deleted from the user App list. When the client App A is executed again in an online state after the reinstallation of the client App A, the client App A uses user data if the user data exists.

(Case No. 12)

Assume that, when “online” is designated for the executable condition of the client App (valid-state) and “application-and-userdata” is designated for the force-uninstall, a network state is transited as the following. Namely, the network state is changed from a state in which WiFi is valid and is connected to a specified access point to a state in which WiFi is invalid and is connected to an arbitrary access point. In this case, a client App A being used is forcibly terminated, a client body and user data are uninstalled, and the client App A is deleted from a user App list. When the client App A is executed in an offline state, the client App body and the user data are uninstalled, and the client App A is deleted from the user App list. When the client App A is executed again in an online state after the reinstallation of the client App A, the user data goes into an initialization state.

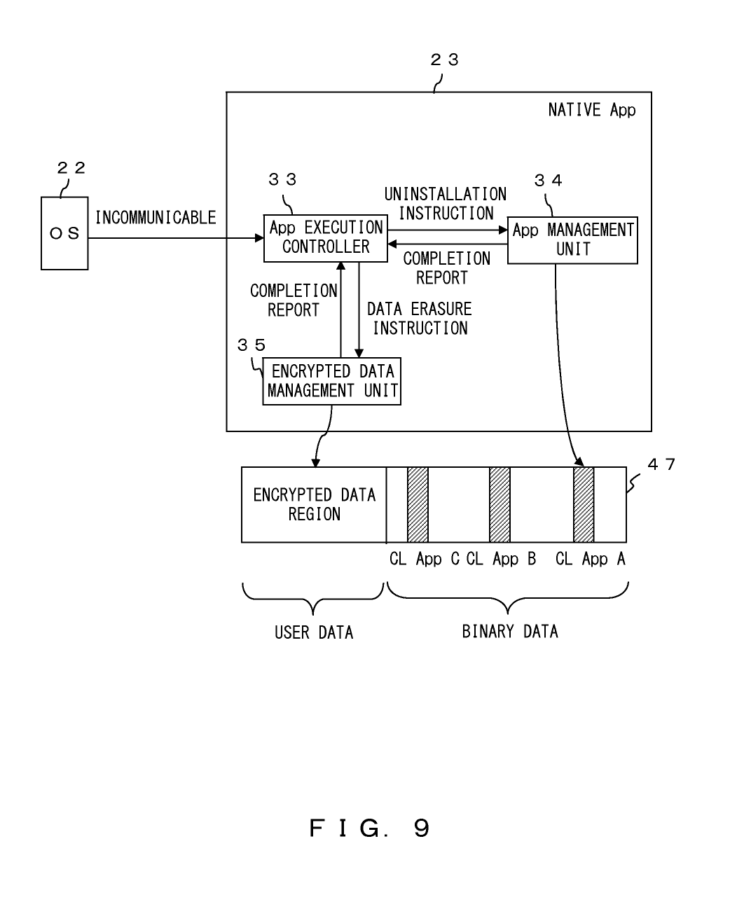

FIG. 9 is a diagram explaining processes of uninstalling a client App and deleting user data according to the first embodiment. An App execution controller 33 receives, from an OS 22, a report indicating that the OS 22 is incommunicable. Then, as illustrated in FIG. 8, the App execution controller 33 performs the following process when the transition of a communication state does not meet the executable condition defined in the operation definition information 36 and the force-uninstall is designated. Namely, the App execution controller 33 issues an instruction to uninstall the client App to an App management unit 34, and issues an instruction to delete the user data to an encrypted data management unit 35.

The App management unit 34 uninstalls the client App (binary data) from a storage device 47 on the basis of the instruction from the App execution controller 33. After the uninstallation has been completed, the App management unit 34 notifies the App execution controller 33 of the completion of the uninstallation of the client App

The encrypted data management unit 35 erases the user data from an encrypted data region 48 on the basis of the instruction from the App execution controller 33. After the erasure of the user data, the encrypted data management unit 35 notifies the App execution controller 33 of the completion of the erasure of the user data.

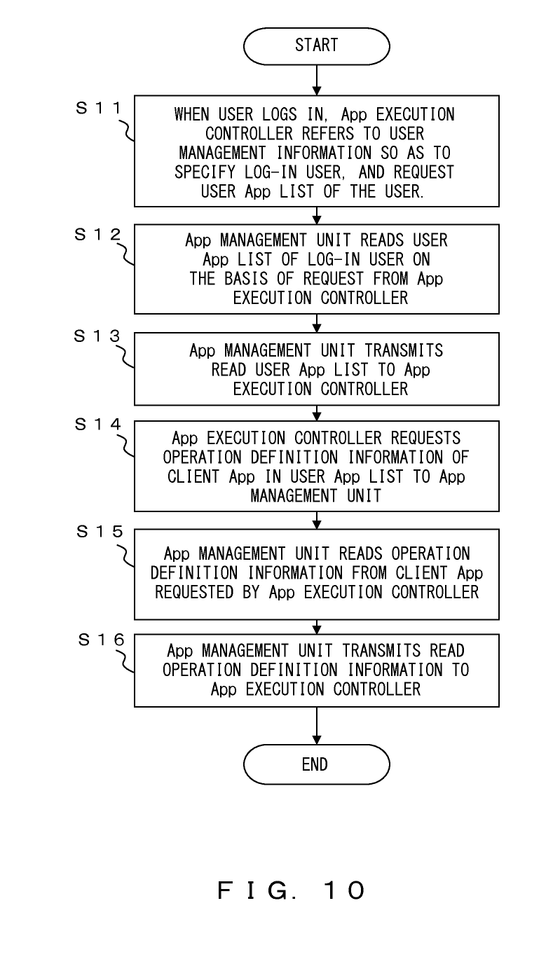

FIG. 10 is a flowchart illustrating a process of obtaining operation definition information according to the first embodiment. When a user logs in to the OS 22, the App execution controller 33 refers to user management information 39 so as to specify a log-in user, notifies the App management unit 34 of a user ID of the user, and requests a user App list 38 of the user (S11).

On the basis of the request from the App execution controller 33, the App management unit 34 reads the user App list 38 of the log-in user from the storage device 47 using the user ID as a key (S12). The App management unit 34 transmits the read user App list 38 to the App execution controller 33 (S13).

The App execution controller 33 requests operation definition information of each of the client Apps in the user App list 38 to the App management unit 34 (S14).

The App management unit 34 reads the operation definition information 36 from each of the client Apps requested by the App execution controller 33 (S15).

The App management unit 34 transmits the read operation definition information 36 to the App execution controller 33 (S16).

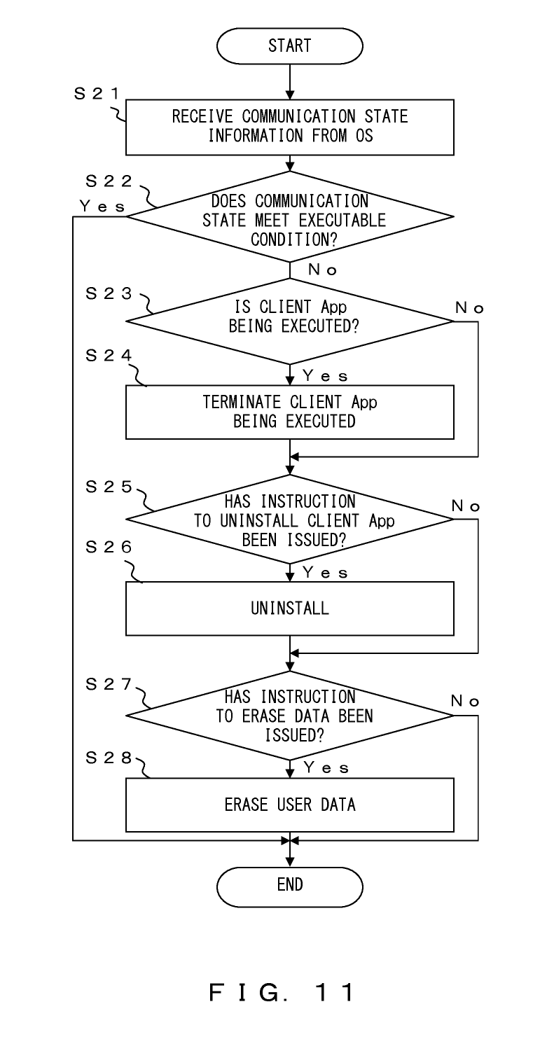

FIG. 11 is a flowchart illustrating a process of uninstalling a client App or erasing user data according to the first embodiment.

The communication state obtaining unit 32 obtains communication state information of the terminal 21 from the communication state monitor 31 on the OS side, and transmits the obtained communication state information to the App execution controller 33 (S21).

The App execution controller 33 determines, on the basis of the communication state information, whether the communication state of the terminal 21 meets an executable condition defined in the operation definition information 36 received from the App management unit 34, as described with reference to FIG. 8 (S22). When the communication state meets the executable condition (“Yes” in S22), this flow is finished. When the communication state does not meet the executable condition (“No” in S22), the App execution controller 33 determines whether a client App that does not meet the executable condition (target client App) is being executed (S23). When the target client App is being executed (“Yes” in S23), the App execution controller 33 finishes the execution of the target client App (S24).

When the operation definition information 36 includes an instruction to uninstall the target client App (“Yes” in S25), the App execution controller 33 issues an instruction to uninstall the target client App to the App management unit 34 (S26).

When the operation definition information 36 includes an instruction to erase user data of the target client App (target user data) (“Yes” in S27), the App execution controller 33 issues an instruction to erase the target user data to the encrypted data management unit 35. On the basis of the instruction, the encrypted data management unit 35 erases the target user data (S28).

The first embodiment enables a terminal to individually perform the determination as to whether a client App may be uninstalled autonomously and the installation of the client App.

Further, the native App erases data related to an application so as to erase data without delaying an autonomous uninstallation operation by the application.

### Second Embodiment

In the first embodiment, in an information processing terminal having a multi-user environment, individually controlling an autonomous uninstallation process of an application program in accordance with a communication state of wireless communication in a user environment of a log-in user, has been described. In the second embodiment, individually controlling an autonomous uninstallation process of the same application program in a user environment of a user other than the log-in user, is further described. A configuration of a terminal in the second embodiment is similar to the terminal 21 described in the first embodiment. In addition, in the second embodiment, the same components as those in the first embodiment are described using the same reference numerals, and the descriptions thereof are omitted.

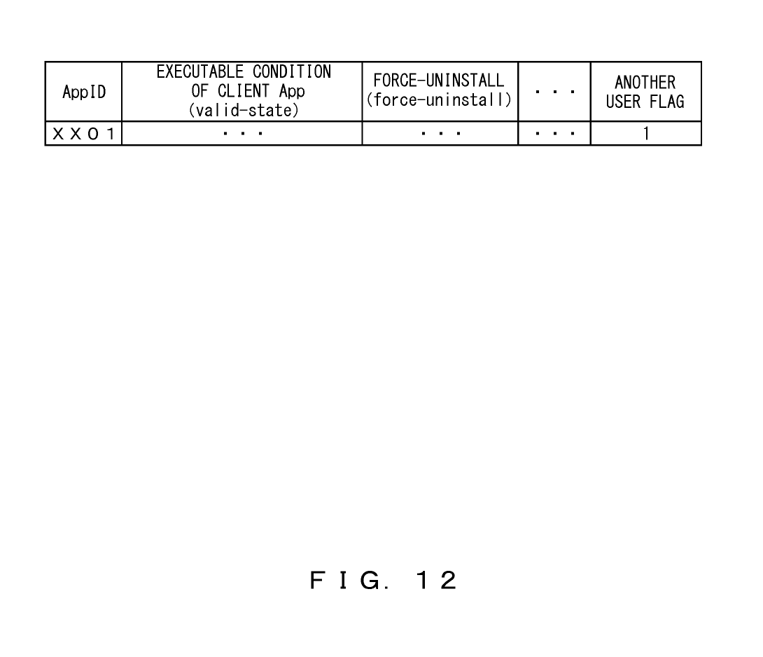

FIG. 12 is a diagram explaining operation definition information according to the second embodiment. The operation definition information includes a “another user flag” in addition to the conditions relating to communication described in the first embodiment. The “another user flag” specifies whether a client App and user data of another user, in addition to a client App and user data of a log-in user, are uninstalled/erased. When “another user flag” is ‘1’, the client App and the user data of another user, in addition to the client App and the user data of the log-in user, are uninstalled/erased. When “another user flag” is ‘0’, only the client App and the user data of the log-in user are uninstalled/erased.

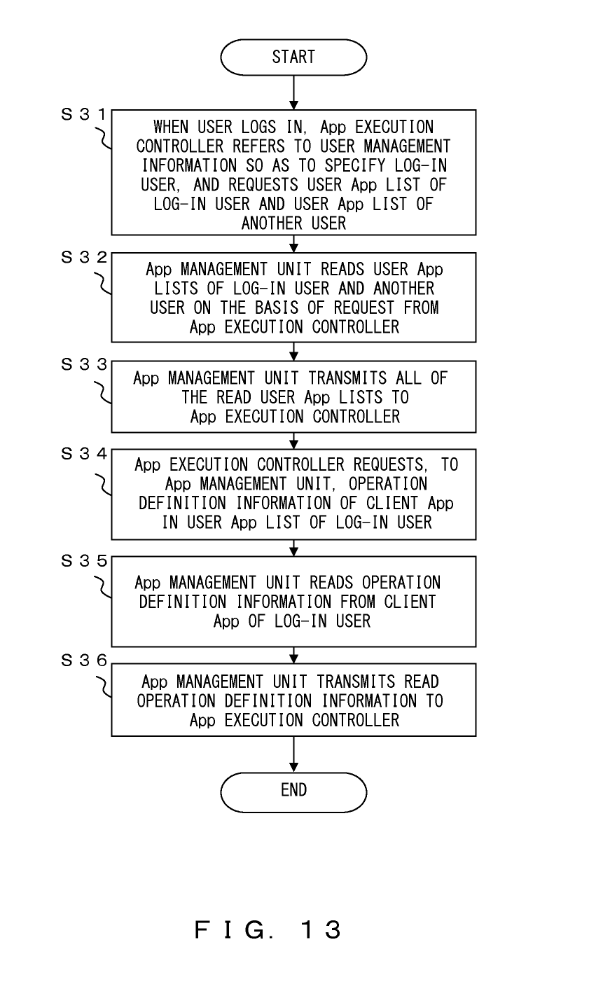

FIG. 13 is a flowchart illustrating a process of obtaining operation definition information according to the second embodiment. When a user logs in to an OS 22, an App execution controller 33 refers to user management information 39 so as to specify a log-in user. Further, the App execution controller 33 refers to the user management information 39 so as to specify a user other than the log-in user (another user) that has been registered in the user management information 39. The App execution controller 33 notifies an App management unit 34 of user IDs of the log-in user and the other user, and requests user App lists 38 for these users (S31).

On the basis of the request from the App execution controller 33, the App management unit 34 reads the user App lists 38 for the log-in user and the other user from a storage device 47 using the user IDs as a key (S32). The App management unit 34 transmits the read user App lists 38 to the App execution controller 33 (S33).

The App execution controller 33 requests, to the App management unit 34, operation definition information of each of the client Apps in the user App list 38 of the log-in user (S34).

The App management unit 34 reads the operation definition information 36 from each of the client Apps of the log-in user that has been requested by the App execution controller 33 (S35).

The App management unit 34 transmits the read operation definition information 36 to the App execution controller 33 (S36).

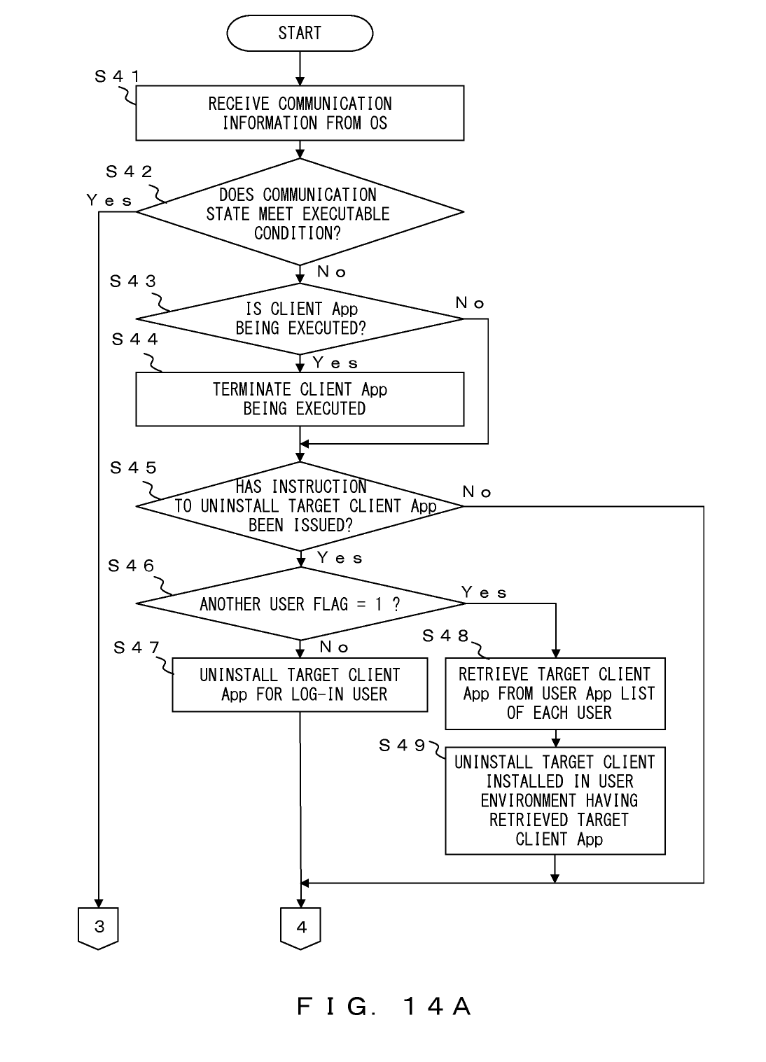

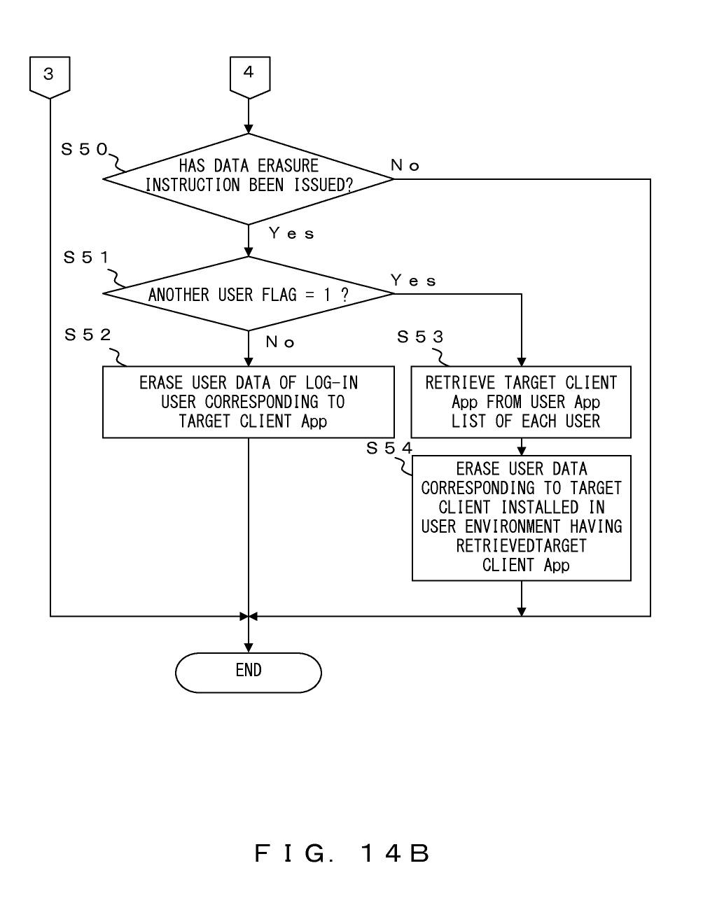

FIG. 14A and FIG. 14B are flowcharts illustrating a process of uninstalling a client App and erasing user data according to the second embodiment.

The communication state obtaining unit 32 obtains communication state information of the terminal 21 from a communication state monitor 31 on the OS side, and transmits the obtained communication state information to the App execution controller 33 (S41).

The App execution controller 33 determines, on the basis of the communication state information, whether the communication state of the terminal 21 meets an executable condition defined in the operation definition information 36 received from the App management unit 34, as described with reference to FIG. 8 (S42). When the communication state meets the executable condition (“Yes” in S42), this flow is finished. When the communication state does not meet the executable condition (“No” in S42), the App execution controller 33 determines whether a client App that does not meet the executable condition (target client App) is being executed (S43). When the target client App is being executed (“Yes” in S43), the App execution controller 33 finishes the execution of the target client App (S44).

When the operation definition information 36 includes an instruction to uninstall the target client App (“Yes” in S45), the App execution controller 33 determines whether another user flag in the operation definition information 36 is ‘1’ (S46).

When another user flag is ‘0’ (“Yes” in S45), the App execution controller 33 issues an instruction to uninstall the target client App for a log-in user to the App management unit 34. On the basis of the instruction, the App management unit 34 uninstalls the target client App (S47).

When another user flag is ‘1’ (“Yes” in S46), the App execution controller 33 retrieves the target client App from a user App list of each user (S48). The App execution controller 33 notifies the App management unit 34 of user IDs of users having the retrieved target client App and a CL App ID of the target client App, and issues an instruction to uninstall the target client Apps of the users. On the basis of the instruction, the App management unit 34 uninstalls the target client Apps corresponding to the notified user IDs (S49).

When the operation definition information 36 does not include an instruction to uninstall the target client App (“No” in S45), the process proceeds to S50.

When the operation definition information 36 includes an instruction to erase the user data of the target client App (target user data) (“Yes” in S50), the App execution controller 33 determines whether another user flag in the operation definition information 36 is 1 (S51).

When another user flag is ‘0’ (“No” in S51), the App execution controller 33 issues an instruction to erase the target user data of the log-in user to an encrypted data management unit 35. On the basis of the instruction, the encrypted data management unit 35 erases the target user data of the log-in user (S52).

When another user flag is ‘1’ (“Yes” in S50), the App execution controller 33 retrieves a target client App from a user App list of each user (S53). The App execution controller 33 notifies the encrypted data management unit 35 of user IDs of users having the retrieved target client App and a CL App ID of the target client App, and issues an instruction to erase pieces of the target user data of the users. On the basis of the instruction, the encrypted data management unit 35 reports the user IDs of the user having the retrieved target client App and the CL App ID of the target client App, and erases the pieces of the target user data of the users (S54).

As described above, it is possible to uninstall/erase a target client App and/or target user data of another user, in addition to a target client App and target user data of a log-in user.

The second embodiment enables a terminal to autonomously perform not only the uninstallation of target client Apps of another user in addition to a log-in user but also the erasure of pieces of user data of the users.

In addition, according to the first and second embodiments, an uninstallation function does not need to be incorporated into each client App, and each of the client Apps does not duplicate the determination as to uninstallation and the performing of the uninstallation, and therefore the resources of a terminal is not wasted. In addition, one client App is not affected by another client App, and therefore an uninstallation process is surely performed.

One aspect of the present invention enables individually controlling an autonomous uninstallation process of an application program in accordance with a communication state of wireless communication.

The present embodiments are not limited to the embodiments as described above, but various configurations and embodiments can be applied without departing from the spirit and scope of the present embodiments.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. Anon-transitory computer-readable storage medium having stored therein a control program that causes an information processing terminal with a wireless communication function to execute a process comprising:
obtaining operation definition information from an application program stored in the information processing terminal, the operation definition information defining a process performed in accordance with whether wireless communication is available; and
uninstalling the application program corresponding to the operation definition information on the basis of the operation definition information when the wireless communication is unavailable.

2. The non-transitory computer-readable storage medium according to claim 1, the process further comprising:
uninstalling the application program corresponding to the operation definition information on the basis of the operation definition information and erasing data related to the application program when the wireless communication is unavailable.

3. An information processing terminal comprising:
a communication unit that performs wireless communication;
a storage unit that stores an application program to which operation definition information has been as signed that defines a process performed in accordance with whether the wireless communication is available; and
a controller that uninstalls the application program corresponding to the operation definition information on the basis of the operation definition information when the wireless communication is unavailable.

4. The information processing terminal according to claim 3, wherein
when the wireless communication is unavailable, the controller further uninstalls the application program corresponding to the operation definition information on the basis of the operation definition information, and erases data related to the application program.

5. An information processing terminal comprising:
a communication unit that performs wireless communication;
a storage unit that stores an application program associated with user environment information that manages a use environment of a log-in user, for each piece of the user environment information, the application program being assigned with operation definition information that defines a process performed in accordance with whether the wireless communication is available; and
a controller that uninstalls a target application program corresponding to user environment information of a log-in user on the basis of the operation definition information of the target application program corresponding to the user environment information of the log-in user when the wireless communication is unavailable.

6. An information processing terminal comprising:
a communication unit that performs wireless communication;
a storage unit that stores an application program associated with user environment information that manages a use environment of a log-in user, for each piece of the user environment information, the application program being assigned with operation definition information that defines a process performed in accordance with whether the wireless communication is available; and
a controller that uninstalls a target application program corresponding to user environment information of a log-in user and user environment information of a user that has not logged in on the basis of the operation definition information of the target application program corresponding to the user environment information of the log-in user when the wireless communication is unavailable.
